(19) United States
(12) Patent Application Publication
(10) Pub. No.: US 2018/0094794 A1
(43) Pub. Date: Apr. 5, 2018

(54) RETRACTABLE, DECORATIVE, EXTERIOR LED LIGHTING SYSTEMS AND METHODS

(71) Applicant: Ashwin Nivas Datta, Hillsboro, OR (US)

(72) Inventor: Ashwin Nivas Datta, Hillsboro, OR (US)

(21) Appl. No.: 15/285,870

(22) Filed: Oct. 5, 2016

(51) Int. Cl. F21V 14/02; E04F 19/02; F21S 8/00; F21V 21/15; F21V 23/00; F21S 10/02

(52) U.S. Cl. CPC F21V 14/02; E04F 19/02; F21S 8/036; F21W 2121/00; F21V 23/003; F21S 10/02; F21V 21/15

(57) ABSTRACT

The disclosed retractable, decorative, exterior LED lighting systems include a building mount coupled to a building structure, an actuator motor assembly coupled to the building mount, a control axle driven by the actuator motor assembly, a cogged rail driven by the control axle, and an LED rod (that includes LED lamps) coupled to the cogged rail. The LED rod has a revealed configuration in which the LED rod projects below an eave of the building structure, and a concealed configuration in which the LED rod is relatively closer to the building structure and hidden behind the eave. The cogged rail is driven perpendicular to the control axle (i.e., generally towards and away from the building structure) and is configured to transition the LED rod between the revealed configuration and the concealed configuration based upon displacement of the cogged rail by motion of the actuator motor assembly.

### FIELD

The present disclosure relates to retractable, decorative, exterior LED (light emitting diode) lighting systems and methods.

### BACKGROUND

Many people have expressed the lack of versatility and flexibility of existing holiday lighting systems typically used to decorate structures like homes and buildings. The lighting systems usually are chosen to showcase underlying themes in different colors (e.g., red and green for Christmas, orange for Halloween, etc.). Such decorative lighting systems typically are temporarily installed on the structures to be decorated for a relatively short period of time (e.g., a given holiday season). This translates to recurring efforts of installation, removal, and safe storage of long strings of light decorations. Home owners and professional decorators have been living with both inconvenience and recurring costs of labor. In some instances, the structures to be decorated are huge and are not easily accessible (without the use of specialized equipment), thus increasing the overall cost.

Conventional systems do not have the flexibility to easily adapt to all of the consumer's building decorating themes, desires, and requirements, and have a high total end cost to the user.

### SUMMARY

The disclosed retractable, decorative, exterior LED lighting systems may be mounted to a building structure under an eave to decorate the building structure. The LED lighting systems include a building mount coupled to the building structure, an actuator motor assembly coupled to the building mount, a control axle driven by the actuator motor assembly, a cogged rail driven by the control axle, and an LED rod (that includes LED lamps) coupled to the cogged rail. The LED rod has a revealed configuration in which the LED rod projects below the eave of the building structure, and a concealed configuration in which the LED rod is relatively closer to the building structure and hidden behind the eave (above the lowest portion of the eave). The cogged rail is driven perpendicular to the control axle (i.e., generally towards and away from the building structure) and is configured to transition the LED rod between the revealed configuration and the concealed configuration based upon displacement of the cogged rail by motion of the actuator motor assembly.

Methods of controlling retractable, decorative, exterior LED lighting systems include deploying and retracting the LED rod with LED lamps and include displaying color patterns with the LED lamps. Methods may include deploying the LED rod with LED lamps into a revealed configuration in which the LED rod projects below the eave of the building structure, determining a color pattern to display with the LED lamps, illuminating the LED lamps with the color pattern, repeating the determining and the illuminating until a termination event, turning off the LED lamps, and retracting the LED rod into a concealed configuration in which the LED rod is relatively closer to the building structure and hidden behind the eave.

### BRIEF DESCRIPTION OF THE DRAWINGS

FIG. 1 is a schematic representation of a retractable, decorative, exterior LED lighting system according to the present disclosure.

FIG. 2 is a schematic representation of an example of a drive gear assembly mated to a cogged rail of a retractable, decorative, exterior LED lighting system according to the present disclosure.

FIG. 3 is a schematic representation of an example of a retractable, decorative, exterior LED lighting system in a revealed configuration.

FIG. 4 is a schematic representation of the example of the retractable, decorative, exterior LED lighting system of FIG. 3 in a concealed configuration.

FIG. 5 is a schematic representation of the example of the retractable, decorative, exterior LED lighting system of FIGS. 3-4 in a downlight configuration.

FIG. 6 is a control diagram of a retractable, decorative, exterior LED lighting system according to the present disclosure.

FIG. 7 is a schematic representation of methods according to the present disclosure.

### DESCRIPTION

This disclosure relates generally to decorative exterior LED lighting systems, and more specifically, to electro-mechanically retractable LED-based lighting systems. The LED lighting systems of the present disclosure have a revealed configuration (also called a deployed configuration) and a concealed configuration (also called a retracted configuration). In the revealed configuration, LED lamps of the LED lighting system are visible beneath the eaves of a building structure. In the concealed configuration, the LED lamps are hidden under the eaves and closer to the building. The LED lamps may be retracted and deployed by a microcontroller-driven cogged rail mechanism.

The LED lighting systems of the present disclosure are generally multicolor systems that may implement different color decoration themes. Further, the LED lighting systems of the present disclosure may be operated by a variety of both local and remote inputs and pre-programmed schedules.

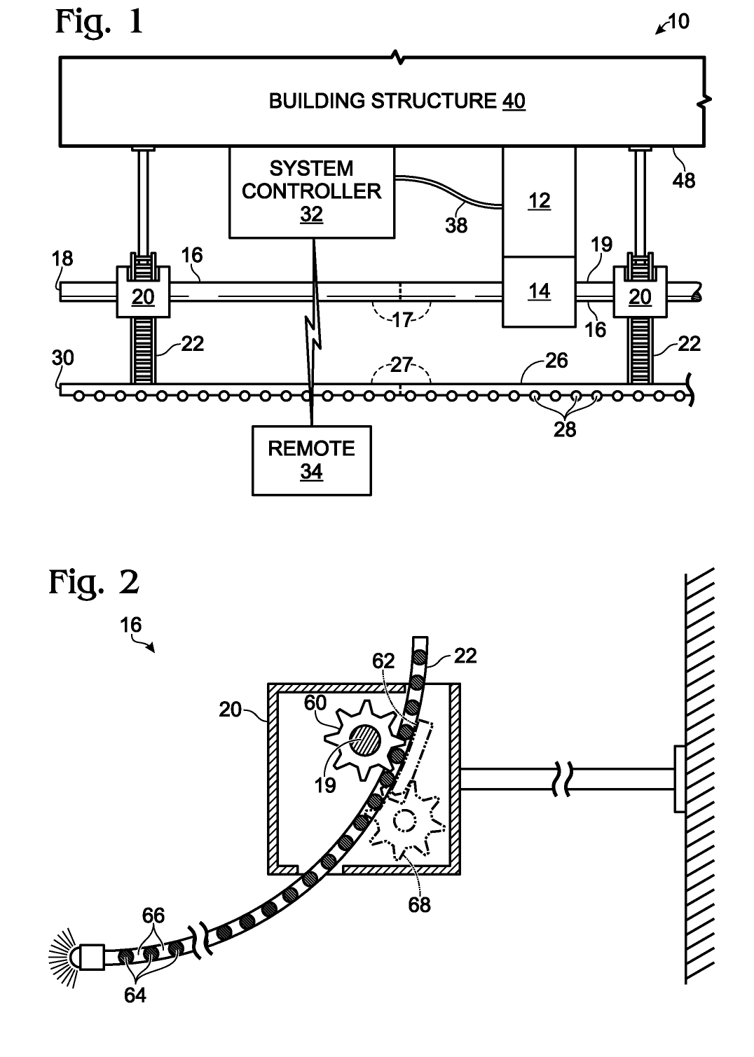

FIGS. 1-7 illustrate retractable, decorative, exterior LED lighting systems and methods. In general, in the drawings, elements that are illustrated in a particular figure are not essential to all embodiments of the present disclosure, and an element shown may be omitted from a particular embodiment without departing from the scope of the present disclosure. Elements that serve a similar, or at least substantially similar, purpose are labelled with numbers consistent among the figures. Like numbers in each of the figures, and the corresponding elements, may not be discussed in detail herein with reference to each of the figures. Similarly, all elements may not be labelled or shown in each of the figures, but reference numerals associated therewith may be used for consistency. Elements, components, and/or features that are discussed with reference to one or more of the figures may be included in and/or used with any of the figures without departing from the scope of the present disclosure.

FIG. 1 schematically illustrates an LED lighting system 10 (also called a retractable, decorative, exterior LED lighting system). The LED lighting system 10 includes a building mount 12, an actuator motor assembly 14, a control axle 16, and an LED rod 26.

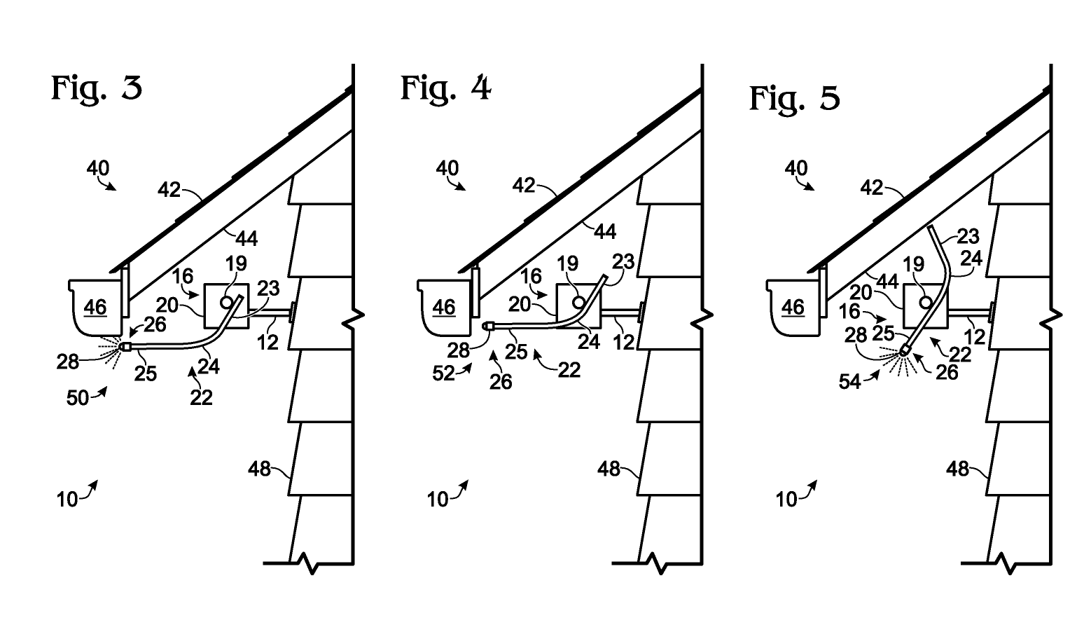

The building mount 12 is coupled to a building structure 40, e.g., at a wall 48 of the building structure 40. The wall 48 is generally a substantially vertical exterior wall. Additionally or alternatively, the building mount 12 may be coupled to an eave and/or soffit associated with the wall 48. The building mount 12 is generally coupled to the exterior of the building structure 40. The building mount 12 generally is coupled under the eave of the building structure. The building mount 12 generally is placed to hide the building mount 12 from the perspective of a person viewing the whole LED lighting system 10 on the building structure 40 (e.g., from a sidewalk or street perspective), referred to herein as the viewing perspective. Hence, the building mount 12 generally is hidden from view when the LED rod 26 is in a revealed configuration 50 (FIG. 3) and when in a concealed configuration 52 (FIG. 4). The building mount 12 may include, and/or may be, a bracket, a brace, a strut, a strap, and/or a beam. Building mounts 12 may be configured to support the actuator motor assembly 14 and/or other components of the LED lighting system 10. For example, each actuator motor assembly 14 may have an associated building mount 12 to support the actuator motor assembly 14. Additionally or alternatively, building mounts 12 may be configured to support the control axle 16 independent of the actuator motor assembly 14.

The actuator motor assembly 14 is coupled to the building mount 12 and hence is coupled to the building structure 40. The actuator motor assembly 14 generally is directly coupled to the building mount 12, e.g., with a fastener, an interference fit, a snap fit, etc. Additionally or alternatively, the actuator motor assembly 14 may be directly coupled to the building structure 40 (and a separate building mount 12 may not be needed). Generally, the actuator motor assembly 14 is spaced away from the building structure 40 and arranged such that the actuator motor assembly 14 is hidden from view as observed from the viewing perspective. Hence, the actuator motor assembly 14 generally is hidden from view when the LED rod 26 is in the revealed configuration 50 (FIG. 3) and when in the concealed configuration 52 (FIG. 4).

Generally, the LED lighting system 10 includes at least one actuator motor assembly 14 for each controlled section of the LED lighting system 10 (i.e., a section that may be independently deployed or retracted). For example, one actuator motor assembly 14 may control the deployment state (e.g., revealed or concealed) for an entire controlled section. As another example, two actuator motor assemblies 14 may together control the deployment state for an entire controlled section (e.g., if operation of the two actuator motor assemblies 14 is coordinated). In such a configuration, the actuator motor assemblies 14 may be located at opposite ends of a controlled section (e.g., at opposite ends 18 of the control axle 16).

The actuator motor assembly 14 includes an actuator such as an electric motor and is configured to drive the control axle 16. The control axle 16 is driven by the actuator motor assembly 14 in a rotary fashion with the control axle 16 rotating along its longitudinal axis. The control axle 16 generally is arranged horizontally and generally parallel to the surface of the building structure 40 to which the actuator motor assembly 14 is coupled (e.g., parallel to the wall 48 of the building structure 40). The control axle 16 generally is rigid (e.g., formed substantially of metal) and lightweight (e.g., may be tubular). The control axle 16 may include a series of control axle members 17. Each control axle member 17 may be configured to couple with other control axle members 17 to form the control axle 16. For example, the control axle members 17 may be configured to fit together in an interference fit, a friction fit, and/or a snap fit. Additionally or alternatively, the control axle members 17 may be fit together with integrated or independent fasteners. Generally, the control axle members 17 are configured so that the control axle 16 may be extended or shortened by adding or removing a control axle member 17.

The control axle 16 is configured to transfer power from the actuator motor assembly 14 into motion of a cogged rail 22. The control axle 16 includes a drive gear assembly 20 that is engaged with the cogged rail 22 to drive the cogged rail perpendicular to the longitudinal axis of the control axle 16.

As shown in FIG. 2, the drive gear assembly 20 includes a pinion gear 60 that is configured to engage the cogged rail 22 and to drive the cogged rail 22 in response to rotation of the control axle 16. The pinion gear 60 may be coupled to a longitudinal body 19 of the control axle 16 and/or may be formed integrally around the circumference of the longitudinal body 19 of the control axle 16 (e.g., the control axle 16 may include cogs around the circumference at least in a region near the drive gear assembly 20). The drive gear assembly 20 may include more than one pinion gear 60 and the pinion gears 60 may be arranged with inline axes or offset, parallel axes. For example, one pinion gear 60 may be located on either side of the cogged rail 22 and/or two pinion gears 60 may be located on the same side of the cogged rail 22.

The drive gear assembly 20 may include a rail guide 62 that is configured to restrict the relative engagement angle between the cogged rail 22 and the control axle 16. The rail guide 62 may be a rigid surface configured to maintain the cogged rail 22 between the rail guide 62 and the pinion gear 60. The rail guide 62 may be a gear, such as another pinion gear 60, which may be driven or not driven (a follower gear 68). The gear may be configured to maintain the cogged rail 22 between the rail guide 62 and the pinion gear 60.

The drive gear assembly 20 and the cogged rail 22 are in a rack and pinion arrangement, with the drive gear assembly 20 including the pinion gear 60 and the cogged rail 22 serving as the associated rack. The cogged rail 22 includes a series of teeth 64 separated by apertures 66. The teeth 64 and apertures 66 are arranged to mate with the cogs of the pinion gear(s) of the drive gear assembly 20. The apertures 66 may extend through the cogged rail 22 and/or teeth 64 may be on opposite sides of the cogged rail 22. For example, the cogged rail 22 may be a track with a series of apertures 66 through the track that form a series of webs between the apertures. The webs spanning between the apertures 66 are the teeth 64 of the cogged rail 22. Additionally or alternatively, the cogged rail 22 may include one series of teeth 64 and apertures 66 on one side of the cogged rail 22 and another series of teeth 64 and apertures 66 on the other side of the cogged rail 22.

Referring again to FIG. 1, generally, the LED lighting system 10 includes at least one drive gear assembly 20 and associated cogged rail 22 for each controlled section of the LED lighting system 10 (i.e., a section of the LED rod 26 that may be independently deployed or retracted). For example, one drive gear assembly 20 and associated cogged rail 22 may move (the cogged rail 22 translating perpendicular to the control axle 16) to change the deployment state (e.g., revealed or concealed) for an entire controlled section. As another example, two groups of drive gear assemblies 20 and associated cogged rails 22 may together move to change the deployment state for an entire controlled section (e.g., if operation of the two drive gear assemblies 20 is coordinated, e.g., operated by a single control axle 16). In such a configuration, the drive gear assemblies 20 and associated cogged rails 22 may be located at opposite ends of a controlled section (e.g., at opposite ends 18 of the control axle 16).

The LED rod 26 is coupled to the cogged rail 22, generally at an end region of the cogged rail 22. The LED rod 26 includes a plurality of LED lamps 28. LED lamps 28 are light sources that incorporate one or more LEDs (light emitting diodes) to generate light. For example, an LED lamp 28 may include a red LED to produce red light, a green LED to produce green light, and a blue LED to produce blue light. If each of the incorporated LEDs is independently driven by an electric current, the composite LED lamp may produce light of virtually any color. Such an LED lamp 28 may be referred to as a multi-color LED or LED lamp.

The LED lamps 28 are rigidly coupled together along the LED rod 26 and may be sealed along the LED rod 26 (e.g., environmentally sealed). The LED lamps 28 generally are spaced apart along the LED rod 26 with a constant spacing. One or more of the LED lamps 28 of the LED rod 26 may be electrically coupled together such that all of the coupled LED lamps 28 may be controlled together (all being turned on or off together and/or all being driven to the same color and/or intensity together). The coupled group of LED lamps 28 may be all of the LED lamps 28 of the LED rod 26 or a portion of the LED lamps 28. The LED rod 26 may include one or more independently controlled groups of LED lamps 28.

Each LED lamp 28 is connected to power and/or control signals with LED control cabling 38. The LED control cabling 38 may be routed along and/or within other components of the LED lighting system 10. Additionally or alternatively, the LED control cabling 38 may include portions that are routed independent of other components of the LED lighting system 10. Generally with respect to the LED rod 26, the LED cabling 38 is routed between the LED lamps 28 within the LED rod 26 such that the LED cabling 38 is environmentally shielded.

The LED rod 26 generally is arranged horizontally and generally parallel to the wall 48 associated with the LED lighting system 10. The LED rod 26 is generally long and thin, and the longitudinal axis of the LED rod 26 is arranged horizontally. The LED rod 26 is generally rigid enough to support the LED lamps 28 of the LED rod 26. The LED rod 26 may include a rigid rod (such as a metal or plastic rod) and/or a cable to support the LED lamps 28. If the LED rod 26 includes a cable, the cable generally is sufficiently taut (under tension) to keep the LED lamps 28 in a straight line. The LED rod 26 generally is lightweight and generally weighs less than the control axle 16 (comparing the weight of the LED rod 26 per unit length to the control axle 16 per unit length). The LED rod 26 may be coupled to the cogged rail 22 at an end region 30 of the LED rod 26 and/or at other regions along the LED rod 26. Generally, the LED rod 26 is coupled to a cogged rail 22 at one end region 30 of the LED rod 26 and to another cogged rail 22 at the other end region 30 of the LED rod 26.

The LED rod 26 may include a series of LED rod members 27. The LED rod members 27 may correspond in length, spacing, and/or coupling with the control axle members 17. Each LED rod member 27 may be configured to couple with other LED rod members 27 to form the LED rod 26. For example, the LED rod members 27 may be configured to fit together in an interference fit, a friction fit, and/or a snap fit. Additionally or alternatively, the LED rod members 27 may be fit together with integrated or independent fasteners. Generally, the LED rod members 27 are configured so that the LED rod 26 may be extended or shortened by adding or removing an LED rod member 27. Each LED rod member 27 includes its own LED lamps 28. When the LED rod members 27 are connected, the LED lamps 28 of the individual LED rod members 27 may be also electrically connected.

The cogged rail 22 generally has a curvilinear form and may include one or more curved sections and/or one or more linear sections. As shown in the example of FIGS. 3-5, the shape of the cogged rail 22 is configured to transition the LED rod 26 between the revealed configuration 50 (FIG. 3) and the concealed configuration 52 (FIG. 4) by translation of the cogged rail with respect to the drive gear assembly 20, the control axle 16, and the building structure 40.

The cogged rail 22 is coupled to the LED rod 26, typically with the LED rod 26 coupled at or near an end region of the cogged rail 22. The motion of the LED rod 26 due to translation of the cogged rail 22 is generally perpendicular to the wall 48 of the building structure 40 that is associated with the LED lighting system 10 (e.g., the wall 48 to which the LED lighting system 10 is mounted, as shown in FIG. 3). The curvilinear form of the cogged rail 22 causes the LED rod 26 to move generally toward the associated wall 48 and upward as the LED rod 26 is transitioned from the revealed configuration 50 to the concealed configuration 52.

As shown in the examples of FIGS. 3-5, the LED rod 26 may transition between at least the revealed configuration 50 (FIG. 3) and the concealed configuration 52 (FIG. 4). The LED rod 26 also may have other configuration positions such as a downlight configuration 54 (FIG. 5). The LED lighting system 10 is configured to move the cogged rail 22 to adjust the position of the LED rod 26. The named configuration positions of the LED rod 26 (the revealed configuration 50, the concealed configuration 52, and the optional downlight configuration 54) are associated with different positions of the cogged rail 22 with respect to the drive gear assembly 20. For example, the revealed configuration 50, the concealed configuration 52, or the downlight configuration 54 may be associated with an end region of the cogged rail 22 (e.g., as shown for the revealed configuration 50 in FIG. 3). That is, the drive gear assembly 20 may be engaged with one of the end regions of the cogged rail 22 when the LED rod 26 is in the revealed configuration 50, the concealed configuration 52, or the downlight configuration 54.

In the revealed configuration 50 (FIG. 3), the LED rod 26 with the LED lamps 28 is visible from the viewing perspective. The LED lighting system 10 is installed generally under an eave 44 at the edge of a roof 42 of the building structure 40. The edge of the roof 42 may be connected and/or associated with a gutter 46 configured to collect water from the roof 42 and redirect it to other locations. In the revealed configuration 50, the LED rod 26 and the LED lamps 28 project under the lowest portion of the eave 44 (i.e., the LED lamps 28 are below the eave 44). As used herein, the eave 44 includes the optional gutter 46. Hence, the lowest portion of the eave 44 may be an underside of the edge of the roof 42, the gutter 46, or other structure connected to the roof 42. Generally, in the revealed configuration 50, the LED rod 26 and the LED lamps 28 extend away from the wall 48 to the end of the eave 44 or beyond the eave 44 (e.g. to or beyond the end of any associated gutter 46). Additionally, in the revealed configuration 50, the LED lamps 28 face generally horizontally and away from the wall 48. Hence, when the LED lamps 28 are illuminated in the revealed configuration 50, the LED lamps 28 project light directly to a person at the viewing perspective.

In the concealed configuration 52 (FIG. 4), the LED rod 26 with the LED lamps 28 is not generally visible from the viewing perspective. The LED rod 26 is relatively closer to the wall 48 in the concealed configuration 52 as compared to the revealed configuration 50. Additionally, in the concealed configuration 52, the LED rod 26 and the LED lamps 28 are located above the lowest portion of the eave 44 (i.e., the LED lamps 28 are hidden behind the eave 44 from the viewing perspective). Hence, motion of the LED rod 26 from the concealed configuration 52 to the revealed configuration 50 is generally horizontally away from the wall 48 and vertically downward.

In the optional downlight configuration 54 (FIG. 5), the LED rod 26 with the LED lamps 28 is not generally visible from the viewing perspective (like in the concealed configuration 52) and/or the LED lamps 28 face generally downward. In the downlight configuration 54, the LED lamps 28 are arranged such that illumination of the LED lamps 28 projects light under the eaves 44 and not primarily directly to a person at the viewing perspective. The light from the LED lamps 28 generally illuminates the wall 48 and/or the nearby ground. The downlight configuration 54 may also be referred to as a wall wash configuration. In some embodiments, the position of the LED rod 26 is the same or substantially the same in both of the concealed configuration 52 and the downlight configuration 54.

To achieve the various configurations, such as the revealed configuration 50 (FIG. 3), the concealed configuration 52 (FIG. 4), and the option downlight configuration 54 (FIG. 5), while the cogged rail 22 is maintained at a relatively constant angle in the drive gear assembly 20 (and/or at a relatively constant angle with respect to the control axle 16), the cogged rail 22 generally has a curved profile. The profile of the cogged rail 22 may be relatively straight if the transition is primarily a linear transition (e.g., between the revealed configuration 50 and the concealed configuration 52 as shown in the example of FIGS. 3-4). The profile of the cogged rail 22 in general may be similar to a hockey stick, with an ascent-descent portion 23, a curved transition portion 24, and an extension portion 25. In the example of FIGS. 3-5, the ascent-descent portion 23 is configured to transition the LED rod 26 between the revealed configuration 50 and the concealed configuration 52 (with a generally linear motion to raise and lower the LED rod). The curved transition portion 24 is configured to transition the LED rod 26 between the concealed configuration 52 and the downlight configuration 54 (with a generally rotary motion to tilt the LED rod). The extension portion 25 generally is configured to hold the LED rod 26 away from the control axle 16. The ascent-descent portion 23 and the curved transition portion 24 may be cogged with teeth 64 and apertures 66 (as shown in FIG. 2) to assist motion of the cogged rail 22 within the drive gear assembly 20. The extension portion 25 may have no teeth 64 or apertures 66 as the extension portion 25 does not generally engage with the drive gear assembly 20.

Returning to FIG. 1, the LED lighting system 10 may include a system controller 32. The system controller 32 is a computer or computer system that incorporates a processor and memory. The system controller 32 is configured to control one or more components of the LED lighting system 10. Configuration to control the components may include power and/or signal connections (e.g., electrical cable, wired and/or wireless communications links, and/or LED control cabling 38) and may include instructions to perform any of the methods described herein. Instructions may be included in a non-transitory computer-readable medium such as a hard drive, flash memory, etc.

The system controller 32 may be programmed to command the actuator motor assembly 14 to move the cogged rail 22 to transition the LED rod 26 between two or more of the LED rod 26 configuration positions (e.g., the revealed configuration 50, the concealed configuration 52, and/or the downlight configuration 54). In embodiments with more than one actuator motor assembly 14, the system controller 32 may be programmed to coordinate the movement of the actuator motor assemblies 14 such that the cogged rails 22 move together to transition the LED rod 26 between configuration positions. The system controller 32 may be configured to turn on and/or to turn off the LED lamps 28 and may be configured to display one or more color patterns among the LED lamps 28 along the LED rod 26. The system controller 32 may be programmed to coordinate the configuration position of the LED rod 26 and the illumination state (on or off) and/or illumination color of the LED lamps 28. As examples, the system controller 32 may be programmed to maintain the LED lamps 28 in an unilluminated state while the LED rod 26 is in the concealed configuration 52. The system controller 32 may be programmed to illuminate the LED lamps 28 when the LED rod 26 is in the revealed configuration 50. The system controller 32 may be programmed to illuminate the LED lamps when the LED rod 26 is in the downlight configuration 54.

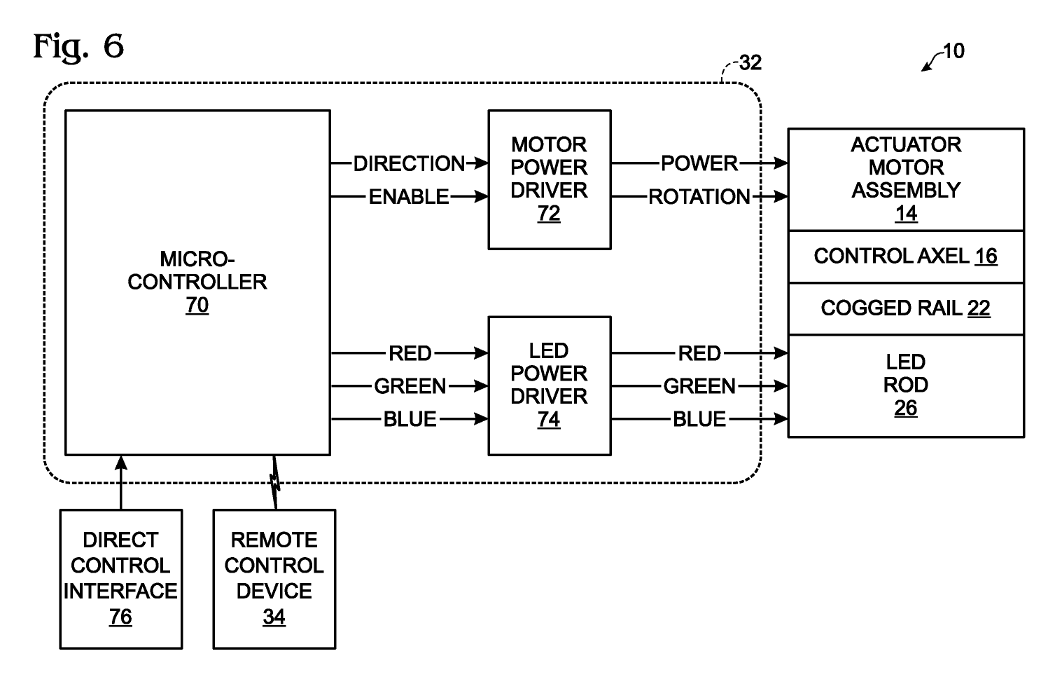

FIG. 6 schematically represents the system controller 32 and interconnection among other components of the LED lighting system 10. The system controller 32 may include a microcontroller 70. Microcontrollers 70 are computer systems that incorporate a processor and memory and are generally characterized by small physical size, energy efficiency, few integrated circuits, a single circuit board, and/or a simple operating system. Examples of microcontrollers 70 include Arduino-brand microcontrollers, Raspberry Pi-brand microcontrollers, and Intel Galileo-brand microcontrollers.

The system controller 32 may include a motor power driver 72 to control the motion of the one or more actuator motor assemblies 14 by regulating the direction, speed, and/or displacement of the actuator motor assemblies 14. The motor power driver 72 may be a stepper motor controller, a DC motor controller (e.g., for brushed or brushless DC motors), an AC induction motor controller, and/or a solenoid motor controller. The system controller 32 may include a different motor power driver 72 for each actuator motor assembly 14 or may include a motor power driver 72 that controls more than one actuator motor assembly 14.

The system controller 32 may include an LED power driver 74 to control the LED lamps 28 by regulating the illumination state and/or color state of the LED lamps 28. The LED power driver 74 may control electrical current and/or voltage to the LED lamps 28 and may include a power supply, a current source, and/or a voltage source. Additionally or alternatively, the LED power driver 74 may incorporate pulse width modulation to control the effective illumination intensity of the LED lamps 28. For LED lamps 28 that have multiple LEDs and/or that have multiple color inputs (such as multicolor LED lamps with a red, green, and blue control input), the LED power driver 74 may independently control each one of the LEDs and/or inputs. The system controller 32 may include a single LED power driver 74 for all or a portion of the LED lamps 28 of the LED rod 26.

The system controller 32 may be controlled through a user interface which may be a part of the system controller 32 and/or independent of the system controller 32. For example, the system controller 32 may include or may be physically coupled to a direct control interface 76 (e.g., buttons, a touch screen, a keyboard, and/or an electronic display). The direct control interface 76 may be electronically coupled to the system controller 32 by wired and/or wireless connections. As another example, the system controller 32 may be configured to communicate with a remote control device 34. The remote control device 34 may include buttons, a touch screen, a keyboard, and/or an electronic display. The remote control device 34 may be electronically coupled to the system controller 32 by wired and/or wireless connections. The remote control device 34 may be a remote computer system (e.g., including a processor and memory) such as a cell phone, a personal computer, etc. The remote control device 34 may be a wireless remote without a processor (e.g., a radio frequency remote control, an infrared remote control).

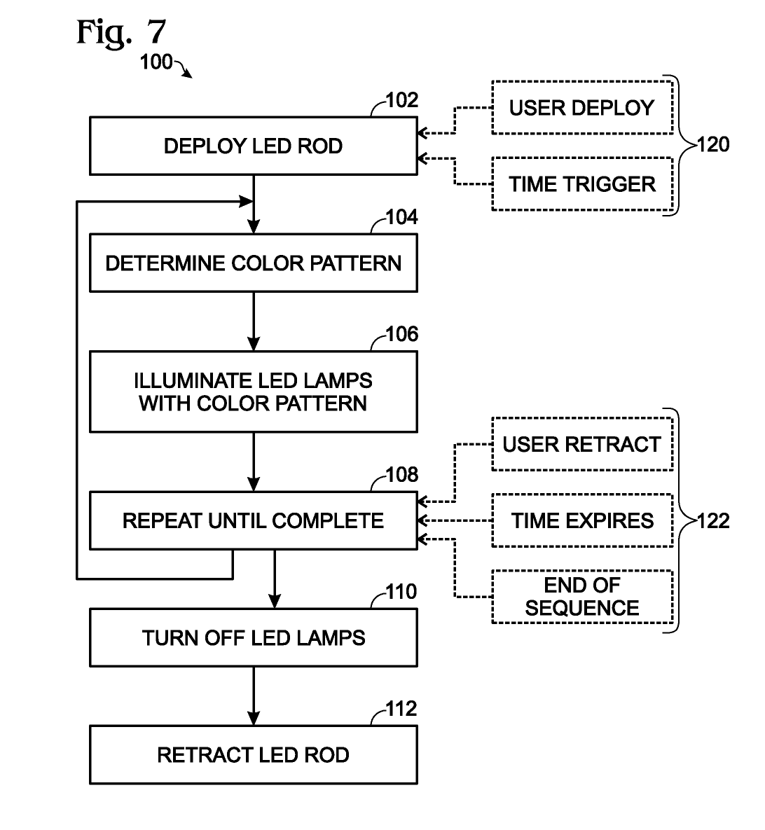

FIG. 7 schematically represents methods 100 according to the present disclosure. Generally, methods 100 of controlling a retractable, decorative, exterior LED lighting system (such as LED lighting system 10) include deploying and/or retracting an LED rod with LED lamps (such as the LED rod 26 with LED lamps 28) and displaying color patterns with the LED lamps of the LED rod. For example, methods 100 may include deploying 102 the LED rod with LED lamps, determining 104 a color pattern for the LED lamps, illuminating 106 the LED lamps with the color pattern, repeating 108 the determining 104 and the illuminating 106 until a termination event 122, turning off 110 the LED lamps, and retracting 112 the LED rod with the LED lamps. Methods 100 and steps of methods 100 may be automated, automatic, and/or performed in whole or part with a system controller such as system controller 32.

Deploying 102 includes deploying the LED rod into an observable configuration (such as revealed configuration 50 or downlight configuration 54). The observable configuration may be a revealed configuration, in which the LED rod projects under a lowest portion of an eave of a building structure associated with the LED rod, or a downlight configuration, in which the LED lamps are arranged such that illumination of the LED lamps projects light under the eave. The LED rod may be a portion of an LED lighting system (such as LED lighting system 10) that is installed on the building structure. Deploying 102 may include sending directional and/or motion signals to an actuator motor assembly (such as actuator motor assembly 14) to drive the actuator motor assembly in a manner that moves the LED from a configuration position in which the LED rod is not visible from a viewing perspective (e.g., the concealed configuration 52) into the revealed configuration or the downlight configuration.

Deploying 102 may be initiated according to one or more trigger events 120. Trigger events 120 may be based in whole or in part upon a user selection, a time (e.g., a relative time since last deployment or concealment, a date, a time of day, an expiration of a timer), a light level (e.g., indicating dusk or night light levels), a temperature level, a sound level, and/or a motion indication (e.g., from a motion sensor indicating a person or vehicle moving near the building structure). Trigger events 120 not requiring specific user control at the moment of the trigger (such as date, time of day, and light level) may provide for an automated and/or automatic control system.

Determining 104 the color pattern may include determining a color, intensity, and/or sequence of illumination for each LED lamp and/or group of LED lamps. The color pattern may be identified by at least one of (a) an index to a table of color patterns, (b) according to input parameters such as the trigger event 120 or events that may be trigger events 120, (c) a prior state of the LED rod (e.g., concealed or revealed), and (d) a prior color pattern. For example, determining 104 may identify a sequence of color patterns and, for each cycle of the repeating 108, the determined color pattern may be incremented to the next color pattern in the sequence.

Illuminating 106 the LED lamps with the color pattern may include supplying power to the LED lamps and/or controlling the intensity and/or color of the LED lamp illumination. For example, illuminating 106 may include supplying red, green, and blue control signals to each of the controlled LED lamps. The red, green, and blue control signals may be arranged to cause the LED lamps to emit the desired color and/or intensity. The control signal(s) supplied to the LED lamps may be pulse width modulated signals and/or current limited signals.

Illuminating 106 the LED lamps with the color pattern may include moving the LED rod. The LED rod may be moved to a fixed position for the color pattern (e.g., moving to the revealed configuration or the downlight configuration). The LED rod may be moved while displaying the color pattern (i.e., while the LED lamps are illuminated with the color pattern).

Repeating 108 may include polling for a termination event 122 and/or checking for events that indicate a color pattern change. Termination events 122 may be based in whole or in part upon a user selection, a time (e.g., a relative time since last deployment or concealment, a date, a time of day, an expiration of a timer), a light level (e.g., indicating dawn or day light levels), a temperature level, a sound level, and/or a motion indication (e.g., from a motion sensor indicating a person or vehicle moving near the building structure). Termination events 120 not requiring specific user control at the moment of the trigger (such as date, time of day, and light level) may provide for an automated and/or automatic control system. Events that may indicate a color pattern change may be based in whole or in part upon a user selection, the determination of a color pattern sequence, a time, or other events that may be termination events 122. For example, repeating 108 may poll for a termination event 122 for a predefined period of time and then, if no termination event 122 was detected, cycle back to determining 104.

Once a termination event 122 is received, methods include turning off 110 the LED lamps. Turning off 110 the LED lamps may include ceasing to supply power to the LED lamps.

Methods include retracting 112 the LED rod after the termination event 122 triggers the end of the repeating 108. Retracting 112 the LED rod may include moving the LED rod into a concealed configuration (such as the concealed configuration 52) in which the LED rod is relatively closer to the building structure and above the lowest portion of the eave of the building structure.

Examples of inventive subject matter according to the present disclosure are described in the following enumerated paragraphs.

A1. A retractable, decorative, exterior LED lighting system comprising:

a building mount coupled to a building structure under an eave of the building structure;

an actuator motor assembly coupled to the building mount;

a control axle driven by the actuator motor assembly;

a cogged rail driven by the control axle and driven perpendicular to a longitudinal axis of the control axle; and

an LED rod that includes a plurality of LED lamps, wherein the LED rod is coupled to the cogged rail, wherein the LED rod has a revealed configuration in which the LED rod projects under a lowest portion of the eave of the building structure, and a concealed configuration in which the LED rod is relatively closer to the building structure and above the lowest portion of the eave of the building structure, and wherein the cogged rail is configured to transition the LED rod between the revealed configuration and the concealed configuration based upon displacement of the cogged rail by motion of the actuator motor assembly.

A2. The LED lighting system of paragraph A1, wherein the control axle is arranged horizontally, and optionally wherein the longitudinal axis of the control axle is arranged horizontally.

A3. The LED lighting system of any of paragraphs A1-A2, wherein the control axle includes a series of control axle members coupled together, optionally by at least one of an interference fit, a friction fit, a snap fit, and a fastener.

A4. The LED lighting system of any of paragraphs A1-A3, wherein the control axle is metal.

A5. The LED lighting system of any of paragraphs A1-A4, wherein the control axle is tubular.

A6. The LED lighting system of any of paragraphs A1-A5, wherein the control axle includes a drive gear assembly that is engaged with the cogged rail to drive the cogged rail perpendicular to the longitudinal axis of the control axle.

A6.1. The LED lighting system of paragraph A6, wherein the drive gear assembly includes a pinion gear that is engaged with the cogged rail.

A6.2. The LED lighting system of any of paragraphs A6-A6.1, wherein the drive gear assembly includes a rail guide to restrict the relative engagement angle between the cogged rail and the control axle, and optionally wherein the rail guide is a follower gear.

A6.3. The LED lighting system of any of paragraphs A6-A6.2, wherein the control axle includes a first drive gear assembly at a first end of the control axle and a second drive gear assembly at a second end of the control axle.

A7. The LED lighting system of any of paragraphs A1-A6.3, wherein the control axle includes cogs to form a/the pinion gear around a circumference of the control axle.

A8. The LED lighting system of any of paragraphs A1-A7, wherein the LED rod is arranged horizontally, and optionally wherein a longitudinal axis of the LED rod is arranged horizontally.

A9. The LED lighting system of any of paragraphs A1-A8, wherein the LED rod includes a series of LED rod members coupled together, optionally by at least one of an interference fit, a friction fit, a snap fit, and a fastener.

A10. The LED lighting system of any of paragraphs A1-A9, wherein the LED rod includes a taut cable that supports the LED lamps.

A11. The LED lighting system of any of paragraphs A1-A10, wherein the LED rod has a downlight configuration in which the LED rod is above the lowest portion of the eave of the building structure and the LED lamps face downward from horizontal, and optionally wherein the cogged rail is configured to transition the LED rod between the downlight configuration and at least one of the revealed configuration and the concealed configuration based upon displacement of the cogged rail by motion of the actuator motor assembly.

A12. The LED lighting system of any of paragraphs A1-A11, wherein the actuator motor assembly is a first actuator motor assembly, the control axle is a first control axle, and the cogged rail is a first cogged rail, wherein the LED lighting system includes a second actuator motor assembly coupled to the building structure, a second control axle driven by the second actuator motor assembly and having a longitudinal axis colinear with the longitudinal axis of the first control axle, and a second cogged rail driven by the second control axle and coupled to the LED rod.

A12.1. The LED lighting system of paragraph A12, further comprising a system controller programmed to coordinate movement of the first actuator motor assembly and the second actuator motor assembly such that the first cogged rail and the second cogged rail move together to transition the LED rod between the revealed configuration and the concealed configuration.

A13. The LED lighting system of any of paragraphs A1-A12.1, further comprising a/the system controller.

A13.1. The LED lighting system of paragraph A13, wherein the system controller is programmed to command the actuator motor assembly to move the cogged rail to transition the LED rod between the revealed configuration and the concealed configuration, and optionally between a/the downlight configuration and at least one of the revealed configuration and the concealed configuration.

A13.2. The LED lighting system of any of paragraphs A13-A13.1, wherein the system controller is programmed to turn on and to turn off the LED lamps.

A13.3. The LED lighting system of any of paragraphs A13-A13.2, wherein the system controller is programmed to cause the LED rod to display a color pattern among the plurality of LED lamps.

A13.4. The LED lighting system of any of paragraphs A13-A13.3, wherein the system controller is programmed to maintain the LED lamps in an unilluminated state while the LED rod is in the concealed configuration.

A13.5. The LED lighting system of any of paragraphs A13-A13.4, wherein the system controller is programmed to illuminate the LED lamps when the LED rod is in the revealed configuration.

A13.6. The LED lighting system of any of paragraphs A13-A13.5, wherein the system controller is programmed to illuminate the LED lamps when the LED rod is in a/the downlight configuration.

A14. The LED lighting system of any of paragraphs A1-A13.6, wherein the LED lamps are sealed along the LED rod.

B1. A method of controlling a retractable, decorative, exterior LED lighting system on a building structure, the method comprising:

deploying an LED rod with a plurality of LED lamps into a revealed configuration in which the LED rod projects under a lowest portion of an eave of the building structure;

determining a color pattern to display with the LED lamps;

illuminating the LED lamps with the color pattern;

repeating the determining and the illuminating until a termination event;

turning off the LED lamps; and

retracting the LED rod into a concealed configuration in which the LED rod is relatively closer to the building structure and above the lowest portion of the eave of the building structure.

B2. The method of paragraph B1, further comprising, while repeating the determining and illuminating, moving the LED rod.

B3. The method of any of paragraphs B1-B2, further comprising cycling through a sequence of color patterns, wherein the determining includes determining a next color pattern of the sequence of color patterns, and wherein the repeating includes repeating until all color patterns in the sequence of color patterns have been displayed.

B4. The method of any of paragraphs B1-B3, wherein the termination event is based at least in part upon at least one of a user selection, a time, a relative time since last deployment, a relative time since last concealment, a date, a time of day, an expiration of a timer, a light level, a temperature level, a sound level, and a motion indication.

B5. The method of any of paragraphs B1-B4, wherein the deploying is in response to receiving a trigger event and optionally wherein the trigger event is based at least in part upon at least one of a user selection, a time, a relative time since last deployment, a relative time since last concealment, a date, a time of day, an expiration of a timer, a light level, a temperature level, a sound level, and a motion indication.

As used herein, the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa. Similarly, subject matter that is recited as being configured to perform a particular function may additionally or alternatively be described as being operative to perform that function.

As used herein, the phrase, “for example,” the phrase, “as an example,” and/or simply the term “example,” when used with reference to one or more components, features, details, structures, embodiments, and/or methods according to the present disclosure, are intended to convey that the described component, feature, detail, structure, embodiment, and/or method is an illustrative, non-exclusive example of components, features, details, structures, embodiments, and/or methods according to the present disclosure. Thus, the described component, feature, detail, structure, embodiment, and/or method is not intended to be limiting, required, or exclusive/exhaustive; and other components, features, details, structures, embodiments, and/or methods, including structurally and/or functionally similar and/or equivalent components, features, details, structures, embodiments, and/or methods, are also within the scope of the present disclosure.

As used herein, the phrases “at least one of” and “one or more of,” in reference to a list of more than one entity, means any one or more of the entities in the list of entities, and is not limited to at least one of each and every entity specifically listed within the list of entities. For example, “at least one of A and B” (or, equivalently, “at least one of A or B,” or, equivalently, “at least one of A and/or B”) may refer to A alone, B alone, or the combination of A and B.

As used herein, the singular forms “a”, “an” and “the” may be intended to include the plural forms as well, unless the context clearly indicates otherwise.

The various disclosed elements of systems and steps of methods disclosed herein are not required of all systems and methods according to the present disclosure, and the present disclosure includes all novel and non-obvious combinations and subcombinations of the various elements and steps disclosed herein. Moreover, any of the various elements and steps, or any combination of the various elements and/or steps, disclosed herein may define independent inventive subject matter that is separate and apart from the whole of a disclosed system or method. Accordingly, such inventive subject matter is not required to be associated with the specific systems and methods that are expressly disclosed herein, and such inventive subject matter may find utility in systems and/or methods that are not expressly disclosed herein.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

1. A retractable, decorative, exterior LED lighting system comprising:
a building mount coupled to a building structure under an eave of the building structure;
an actuator motor assembly coupled to the building mount;
a control axle arranged horizontally and engaged with the actuator motor assembly to drive the control axle about a horizontal, longitudinal axis of the control axle, wherein the control axle includes a drive gear assembly;
a cogged rail that is engaged with the drive gear assembly to drive the cogged rail perpendicular to the horizontal, longitudinal axis of the control axle; and
an LED rod arranged horizontally and that includes a plurality of LED lamps, wherein the LED rod is coupled to the cogged rail, wherein the LED rod has a revealed configuration in which the LED rod projects under a lowest portion of the eave of the building structure, and a concealed configuration in which the LED rod is relatively closer to the building structure and above the lowest portion of the eave of the building structure, and wherein the cogged rail is configured to transition the LED rod between the revealed configuration and the concealed configuration based upon displacement of the cogged rail by motion of the actuator motor assembly.

2. The LED lighting system of claim 1, wherein the drive gear assembly includes a rail guide to restrict the relative engagement angle between the cogged rail and the control axle.

3. The LED lighting system of claim 2, wherein the rail guide is a follower gear.

4. The LED lighting system of claim 1, wherein the drive gear assembly is a first drive gear assembly, wherein the control axle includes the first drive gear assembly at a first end of the control axle and a second drive gear assembly at a second end of the control axle.

5. The LED lighting system of claim 1, wherein the control axle includes cogs to form a pinion gear around a circumference of the control axle.

6. The LED lighting system of claim 1, wherein the LED rod has a downlight configuration in which the LED rod is above the lowest portion of the eave of the building structure and the LED lamps face downward from horizontal.

7. The LED lighting system of claim 6, wherein the cogged rail is configured to transition the LED rod between the downlight configuration and at least one of the revealed configuration and the concealed configuration based upon displacement of the cogged rail by motion of the actuator motor assembly.

8. The LED lighting system of claim 1, wherein the actuator motor assembly is a first actuator motor assembly, the control axle is a first control axle, and the cogged rail is a first cogged rail, wherein the LED lighting system includes a second actuator motor assembly coupled to the building structure, a second control axle engaged with the second actuator motor assembly to drive the second control axle, and a second cogged rail driven by the second control axle and coupled to the LED rod, wherein the second control axle has a longitudinal axis colinear with the horizontal, longitudinal axis of the first control axle; and
wherein the LED lighting system further includes a system controller programmed to coordinate movement of the first actuator motor assembly and the second actuator motor assembly such that the first cogged rail and the second cogged rail move together to transition the LED rod between the revealed configuration and the concealed configuration.

9. The LED lighting system of claim 1, further comprising a system controller that is programmed to command the actuator motor assembly to move the cogged rail to transition the LED rod between the revealed configuration and the concealed configuration, and that is programmed to turn on and to turn off the LED lamps.

10. The LED lighting system of claim 9, wherein the system controller is programmed to cause the LED rod to display a color pattern among the plurality of LED lamps.

11. The LED lighting system of claim 9, wherein the system controller is programmed to maintain the LED lamps in an unilluminated state while the LED rod is in the concealed configuration.

12. The LED lighting system of claim 9, wherein the system controller is programmed to illuminate the LED lamps when the LED rod is in the revealed configuration.

13. The LED lighting system of claim 9, wherein the system controller is programmed to illuminate the LED lamps when the LED rod is in a downlight configuration in which the LED rod is above the lowest portion of the eave of the building structure and the LED lamps face downward from horizontal.

14. The LED lighting system of claim 1, wherein the LED lamps are sealed along the LED rod.

15. The LED lighting system of claim 1, wherein the LED rod includes a series of LED rod members coupled together by interference fits.

16. A method of controlling a retractable, decorative, exterior LED lighting system on a building structure, the method comprising:
deploying an LED rod with a plurality of LED lamps into a revealed configuration in which the LED rod projects under a lowest portion of an eave of the building structure;
determining a color pattern to display with the LED lamps;
illuminating the LED lamps with the color pattern;
repeating the determining and the illuminating until a termination event;
turning off the LED lamps; and
retracting the LED rod into a concealed configuration in which the LED rod is relatively closer to the building structure and above the lowest portion of the eave of the building structure.

17. The method of claim 16, further comprising, while repeating the determining and illuminating, moving the LED rod.

18. The method of claim 16, further comprising cycling through a sequence of color patterns, wherein the determining includes determining a next color pattern of the sequence of color patterns, and wherein the repeating includes repeating until all color patterns in the sequence of color patterns have been displayed.

19. The method of claim 16, wherein the termination event is based at least in part upon at least one of a relative time since the deploying was completed, a time of day, and an expiration of a timer.

20. The method of claim 16, wherein the deploying is in response to receiving a trigger event, wherein the trigger event is based at least in part upon at least one of a user selection, a date, and a time of day.
